(19) United States
(12) Patent Application Publication
(10) Pub. No.: US 2026/0183959 A1
(43) Pub. Date: Jul. 2, 2026

(54) TRAINING METHOD OF LARGE MODEL FOR WIRE HARNESS OPERATION OF HUMANOID ROBOT BASED ON META-ACTION SPACE

(71) Applicant: TONGJI UNIVERSITY, Shanghai (CN)

(72) Inventors: Bin HE, Shanghai (CN); Yanmin ZHOU, Shanghai (CN); Zhongpan ZHU, Shanghai (CN); Chaochen GUO, Shanghai (CN); Yue SONG, Shanghai (CN); Zhipeng WANG, Shanghai (CN)

(73) Assignee: TONGJI UNIVERSITY, Shanghai (CN)

(21) Appl. No.: 19/394,828

(22) Filed: Nov. 19, 2025

(30) Foreign Application Priority Data
Dec. 26, 2024 (CN) 2024119319760

(51) Int. Cl. B25J 9/16; B25J 9/00; B62D 65/02; G05B 13/02; G06N 3/008

(52) U.S. Cl. CPC B25J 9/1687; B25J 9/0081; B25J 9/163; B25J 9/1671; B62D 65/022; G05B 13/027; G06N 3/008

(57) ABSTRACT

The present disclosure relates to a training method of a large model for wire harness operation of a humanoid robot based on a meta-action, which includes: constructing wire-harness-operation meta-actions based on human wire harness operations; constructing a wire-harness-operation meta-action dataset; training the large model for the wire harness operation of the humanoid robot using reinforcement learning based on the wire-harness-operation meta-action dataset; acquiring input data, outputting joint-motor parameters using the trained large model for the wire harness operation of the humanoid robot and updating the input data in real time based on the joint-motor parameters; acquiring a basic strategy and acquiring a residual strategy based on the basic strategy; and performing the wire harness operation of the humanoid robot based on the basic strategy and the residual strategy.

### FIELD OF THE INVENTION

The disclosure relates to the field of embodied intelligence, in particular to a training method of a large model for wire harness operation of a humanoid robot based on a meta-action space.

### BACKGROUND

An automotive wire harness, as a key assembly connecting all types of electronic devices, sensors and control modules of an automotive, is an indispensable part of an automobile electrical system. A traditional assembly-line production method requires burdensome manual labor, which not only causes huge physical burden on workers, but also results in high expenses in labor and operating costs. In recent years, with development of artificial intelligence, machine learning and automation, an intelligent level of a humanoid robot has been significantly improved, which has shown great application and development potential in industrial production, maintenance, medical care and life service. In view of a similar limb structure and motion mode between the humanoid robot and human, it exhibits a good prospect to study robot's autonomous manipulation of a wire harness to replace the traditional assembly-line method.

Currently, methods of training the humanoid robots in China and other countries focus on large model technology, which realizes efficient environmental awareness, independent decision-making, intelligent interaction and others. Although the humanoid robot can complete diversified tasks with aid of the abundant internet knowledge learned by a pre-trained large model, it can show good generalization ability even when facing some invisible simple objects, scenes and tasks in training, but has poor performance in dexterous and complex tasks such as the wire harness operation, and there are some limitations: (1) there are many kinds and complex styles of wire harnesses in actual production, with operation difficulty much higher than the task scene when the large model is pre-trained, and a method of directly deploying the large model without fine-tuning cannot achieve expected effect; (2) a dataset of a wire harness production operation is relatively scarce, and especially in specific tasks and detailed operations, there is not enough training data to support effective training and optimization of large models; (3) a production process of wire harnesses often involves a long sequence of operation tasks, which puts forward higher requirements for performance of large models.

### SUMMARY

The present disclosure provides a training method of a large model for wire harness operation of a humanoid robot based on a meta-action space, so as to solve a generalization problem of a humanoid robot in a complex scene of harness operations, and to provide a large model training method capable of generating more accurate harness operations of a humanoid robot.

The present disclosure may be implemented by following technical solutions.

A training method of a large model for wire harness operation of a humanoid robot based on a meta-action space is provided in the present disclosure, which includes:
constructing wire-harness-operation meta-actions based on human wire harness operations;
acquiring wire-harness-operation meta-actions of the humanoid robot, and constructing a wire-harness-operation meta-action dataset based on the wire-harness-operation meta-actions;
training the large model for the wire harness operation of the humanoid robot using reinforcement learning based on the wire-harness-operation meta-action dataset, and defining a reward function of reinforcement learning based on an output of the large model for the wire harness operation of the humanoid robot;
acquiring input data, outputting joint-motor parameters using the trained large model for the wire harness operation of the humanoid robot and updating the input data in real time based on the joint-motor parameters, the input data including text instructions, visual observation, and robot perception data;
acquiring a basic strategy based on the joint-motor parameters, and training the large model for the wire harness operation of the humanoid robot to acquire a residual strategy in a lifelong learning mode with human behavior intervention based on the basic strategy; and
performing the wire harness operation of the humanoid robot based on the basic strategy and the residual strategy.

As a preferred technical scheme, each of the wire-harness-operation meta-actions includes a wire harness routing task operation, a wire harness wrapping task operation, and a wire harness inspection task operation.

As a preferred technical scheme, the wire harness routing task operation refers to that a robot arranges multiple wire harnesses on a tooling plate as required and fixes positions of the wire harnesses through U-shaped clips arranged on the tooling plate, including: first picking-up, routing, first straightening and moving to a next routing position; in which the first picking-up refers to the robot picking up two specific position points of a wire harness, and lifting the wire harness to a first preset height at a specified speed, with no deviation of picking-up points of the wire harness during the first picking-up, the routing and the first straightening; the routing is performed on a basis of the first picking-up, in which the robot moves and arranges the wire harness from the first picking-up in a U-shaped clip; the first straightening is performed on a basis of the first picking-up, in which two arms of the robot move towards two ends of the wire harness along a direction of the wire harness to straighten the wire harness; and moving to the next routing position is performed after the routing is finished, in which the two arms of the robot releases the wire harness and moves to the next routing position.

The wire harness wrapping task operation refers to the robot picking up an adhesive tape to wrap multiple wire harnesses on the pre-routed tooling plate, including: second picking-up, wrapping, and tearing off the adhesive tape, in which the second picking-up refers that the two arms of the robot pick up position points of the adhesive tape and lift the adhesive tape to a second preset height at a preset speed, with no deviation of picking-up points of the adhesive tape during the whole picking-up; the wrapping is performed on a basis of the second picking-up, in which the robot grasps the adhesive tape to wrap multiple wire harnesses on the tooling plate; and the tearing off the adhesive tape is performed on a basis of wrapping, in which the wrapping adhesive tape is cut off from the wrapped wire harness;

The wire harness inspection task operation refers to the robot installing the assembled wire harness on an inspection platform, and docking a connecting socket equipped on the inspection platform with a connector at an end of the wire harness, including: third picking-up and placing, plugging, second straightening and moving to a next plugging position, in which the third picking-up and placing refers to the robot picking up two position points of the wire harness, moving to a third preset height above the inspection platform, placing the wire harness on the inspection platform and releasing the wire harness; the plugging refers to that one arm of the robot picks up an end of the wire harness, while the other arm of the robot picks up a connector at the end, and the two arms of the robot move to plug the connector into a corresponding slot of the inspection platform; the second straightening refers to that the two arms of the robot grasp the wire harness and move towards the two ends along the direction of the wire harness so as to straighten the wire harness; and the moving to the next plugging position is performed after the plugging is completed, in which the two arms of the robot releases the wire harness and moves to the next plugging position on the inspection platform.

As a preferred technical scheme, constructing the wire-harness-operation meta-action dataset includes:
teaching the robot and collecting all robot actions during the teaching; and
sorting and classifying all collected robot actions into different wire-harness-operation meta-actions based on the wire-harness-operation meta-actions, so as to obtain the wire-harness-operation meta-action dataset by integration.

As a preferred technical scheme, the teaching is virtual reality teaching.

As a preferred technical scheme, an expression of the reward function is as follows:

$$R = {\sum }_{t = 0}^{T} {γ}^{t} {r}_{t} ( {v}_{t} , {p}_{t} , {q}_{t} , {\dot{q}}_{t} , {\ddot{q}}_{t} ) ,$$

in which rₜ(vₜ, pₜ, qₜ, \dot{q}ₜ, \ddot{q}ₜ) indicates an instant reward calculated according to a current state of the humanoid robot and the joint-motor parameters when performing an action at time horizon t; γ is a discount factor; T is a time horizon; vₜ indicates visual observation; pₜ indicates perception data; qₜ indicates an angle of a motor joint when performing an action, \dot{q}ₜ indicates a speed of the motor joint when performing an action, and \ddot{q}ₜ indicates an acceleration of the motor joint when performing an action.

As a preferred technical scheme, the method further includes constructing the meta-action space based on the wire-harness-operation dataset, which includes:
extracting a joint dynamics representation corresponding to each data in the wire-harness-operation meta-action dataset, and encoding the joint dynamics representation to obtain a joint dynamics feature; and
integrating all of joint dynamics features to generate the meta-action space.

As a preferred technical scheme, the outputting the joint-motor parameters includes:
discretizing the text instruction, the visual observation and the perception data to obtain discretized data; and
dynamically selecting a joint dynamics feature based on the discretized data, and generating joint-motor parameters for generalized execution of actions obtained according to the dynamically selected joint dynamics feature, with an expression as follows:

$$m = {f}_{1} ( {v}_{t} , l , {p}_{t} , M ) ,$$

$$[ {q}_{t} , {\dot{q}}_{t} , {\ddot{q}}_{t} ] = {f}_{2} ( {v}_{t} , l , {p}_{t} , m ) ,$$

in which m indicates the dynamically selected joint dynamics feature, qₜ indicates an angle of a motor joint when performing an action, \dot{q}ₜ indicates a speed of the motor joint when performing an action, and \ddot{q}ₜ indicates an acceleration of the motor joint when performing an action.

As a preferred technical scheme, acquiring the basic strategy includes: performing strategy transfer on the joint-motor parameters for deploying in a robot to obtain the basic strategy.

As a preferred technical scheme, acquiring the residual strategy includes:
performing manual interruption and correction when the humanoid robot performs the basic strategy abnormally; and
collecting interruption data and correction data so as to generate the residual strategy by using reinforcement learning.

Compared with related art, the disclosure has following advantages.
1) The present disclosure provides the training method for the wire harness operation of the humanoid robot based on the meta-action space, which plans complex wire harness operation tasks into relatively simple meta-action combinations, and integrates the wire harness operation of the humanoid robot under guidance of the collected meta-action combinations into the dataset, thus solving a problem of lack of training data for harness operations and improving model's understanding and execution of complex harness operation tasks.
2) In the present disclosure, a pre-trained large model framework is fine-tuned through reinforcement learning, and the reward function of reinforcement learning is defined based on the output of the large model and impact on environment caused by the robot after executing the output, so that the large model can generate wire harness action more conforming to a current operating environment, which not only retains generalization ability and powerful knowledge reserve of the large model for complex tasks, but also enhances adaptability and execution efficiency in specific wire harness operation tasks.
3) Lifelong learning with human behavior intervention is also added in the disclosure, and with human assistance for the humanoid robot to correct wrong actions, empirical knowledge of wire harness operations and intervention instructions of human behaviors are continuously accumulated in a real harness operation environment, and the residual strategy can be trained, thus realizing lifelong learning of the wire harness operations and continuous advancement of the humanoid robot, which is expected to promote application and popularization of the humanoid robot on a wire harness production line.

### BRIEF DESCRIPTION OF DRAWINGS

FIG. 1 is a flowchart of a method according to the present disclosure;

FIG. 2 is a schematic view of a teaching process of humanoid virtual reality according to the present disclosure;

FIG. 3 is a schematic view of training of an autonomous wire harness operation of a humanoid robot based on a large model according to the present disclosure; and

FIG. 4 is a schematic view of artificially assisted lifelong learning.

### DETAILED DESCRIPTION

The technical schemes in the embodiments of the present disclosure will be clearly and completely described in the following with reference to attached drawings. Obviously, the described embodiments are only a part of the embodiments of the disclosure, but not all of them. On a basis of the embodiments in this disclosure, all other embodiments obtained by the ordinary skilled in the art without any creative effort should be within the protection scope of this disclosure.

Unless otherwise defined, technical terms or scientific terms involved in the disclosure shall have a general meaning understood by those with general skills in the technical field to which this disclosure pertains. Similar words such as “a”, “an”, and “the” involved in this disclosure do not indicates quantity limitation, but indicates singular or plural. Terms “including”, “comprising”, “having” and any variations thereof referred to in the disclosure are intended to cover non-exclusive inclusion. For example, a process, method, system, product or device containing a series of steps or modules (units) is not limited to listed steps or units, but may also include steps or units not listed, or may also include other steps or units inherent to these processes, methods, products or devices. Similar words such as “connected to”, “connected with” and “coupled to” involved in the disclosure are not limited to physical or mechanical connection, but can include electrical connection, direct or indirect. Reference to “multiple” in this disclosure refers to two or more. A term “and/or” describes a relationship of related objects, which means that there can be three kinds of relationships. For example, A and/or B can indicate three situations, only A, A and B, and only B. A character “/” generally indicates that contextual objects are in an “or” relationship. Terms “first”, “second” and “third” involved in the disclosure only serve to distinguish similar objects and do not represent a specific ordering of the objects.

This embodiment provides a training method of a large model for wire harness operation of a humanoid robot based on a meta-action space, including data acquisition, model training, sim-to-real transfer and lifelong learning of the wire harness operation of the humanoid robot, which provides an effective solution for the humanoid robot to perform complex harness operations and is expected to promote application and popularization of the humanoid robot on a wire harness production line.

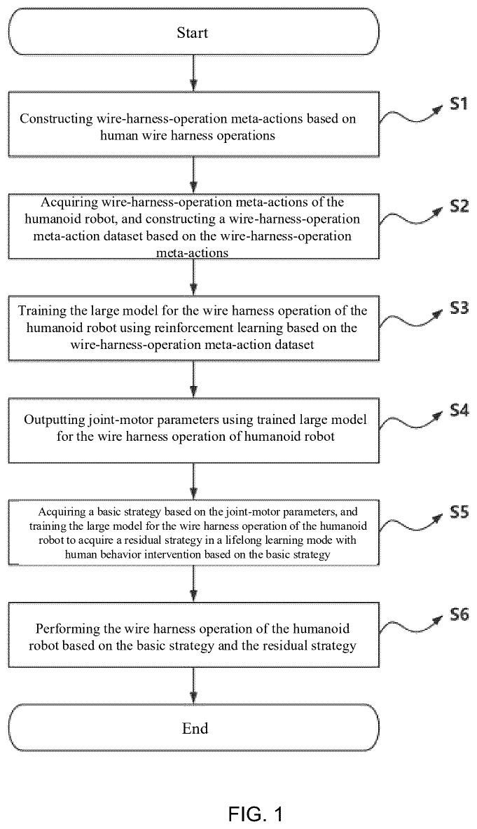

Specifically, a flow of the method is shown in FIG. 1, which includes following steps.
S1, wire-harness-operation meta-actions are constructed based on human wire harness operations.

In detail, the human wire harness operations include following content.
a. Harness routing task operation: in this operation, multiple harnesses are arranged on the tooling plate by two arms of the robot as required, and the positions of the harnesses are fixed by the U-shaped clips arranged on the tooling plate, and meta-actions involved include:
First picking-up: in this action, the robot picks up two specific position points of the wire harness, and lifts the wire harness to a first preset height at a specified speed, with no deviation of picking-up points of the wire harness during the first picking-up, routing and first straightening actions;
Routing: this action is performed on a basis of the first picking-up, in which the robot moves and arranges the wire harness from the first picking-up in the U-shaped clip at a specific position;
First straightening: this action is performed on a basis of the first picking-up, in which the two arms of the humanoid robot move towards two ends along a direction of the wire harness to straighten the wire harness; this meta-action is designed to address difficulties in routing caused by soft and deformable nature of the wire harness; and
Moving to a next routing position: this action is performed after the routing is finished, in which the two arms of the robot release the wire harness and move to the next routing position.

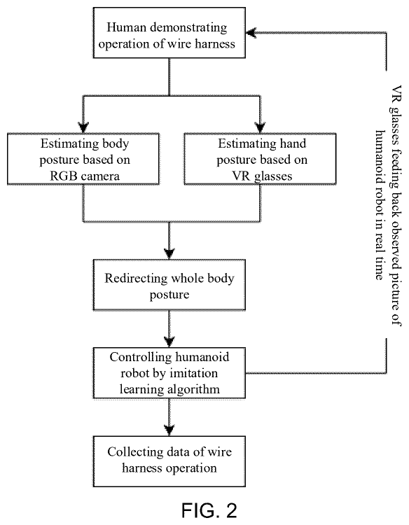

b. Wire harness wrapping task operation: in this operation, the robot picks up the adhesive tape to wrap multiple wire harnesses on the pre-routed tooling plate, and meta-actions involved include:
Second picking-up: in this action, two arms of the robot pick up position points of the adhesive tape and lift the adhesive tape to a second preset height at a preset speed, with no deviation of picking-up points of the adhesive tape during the whole picking-up;
Wrapping: this action is performed on a basis of the second picking-up, in which the robot grasps the adhesive tape to wrap multiple wire harnesses on the tooling plate; and
Tearing off the adhesive tape: this action is performed on a basis of wrapping, in which the robot cut off the wrapping adhesive tape from the wrapped wire harness.
c. Wire harness inspection task operation: in this operation, the robot installs the assembled wire harness on an inspection platform, and docks a connecting socket equipped on the inspection platform with a connector at an end of the wire harness, and meta-actions involved include:
Third picking-up and placing: in this action, the robot picks up two position points of the wire harness, moves the wire harness to a third preset height above the inspection platform, places the wire harness on the inspection platform and releases the wire harness;
Plugging: in this action, one arm of the robot picks up an end of the wire harness, and the other arm of the robot picks up an end of the connector; the robot moves the two arms to plug the connector into a corresponding slot of the inspection platform; and
Second straightening: this action refers to that the two arms of the robot grasp the wire harness and move towards the two ends along the direction of the wire harness so as to straighten the wire harness; this meta-action skill is designed to address difficulties in routing caused by soft and deformable nature of the wire harness; and
Moving to a next plugging position: this action is performed after the plugging is completed, in which the two arms of the robot release the wire harness and move to the next plugging position on the inspection platform.
S2, wire-harness-operation meta-actions of the humanoid robot are acquired, and a wire-harness-operation meta-action dataset is constructed based on the wire-harness-operation meta-actions.
S21, teaching is performed for the robot and all robot actions during the teaching are collected.
S211, a teleoperation platform of a humanoid robot is constructed, as shown in FIG. 2, including a harness operation platform, an RGB camera and VR glasses.
S212, a currently observed picture of the humanoid robot through the VR glasses is synchronously observed and the wire harness operation is performed by a teaching operator.
S213, a body posture of the teaching operator is estimated based on a shot picture of the RGB camera using a human posture estimation algorithm, and a hand posture is calculated by an internal algorithm of the VR glasses.
S214, a whole-body posture of the teaching operator is redirected to a posture of the humanoid robot by using an inverse kinematics method according to the body posture and the hand posture obtained in step S213.
S215, the humanoid robot is caused to perform operations of the wire harness in synchronization with the teaching operator based on an imitation learning algorithm.
S216, an observed picture of the humanoid robot is returned by the VR glasses in real time.
Steps S212 to S216 are repeated to obtain enough robot actions.
S22, all robot actions are sorted and classified into different wire-harness-operation meta-actions based on the wire-harness-operation meta-actions, so as to obtain the wire-harness-operation meta-action dataset by integration.
S3, the large model for the wire harness operation of the humanoid robot is trained using reinforcement learning based on the wire-harness-operation meta-action dataset.

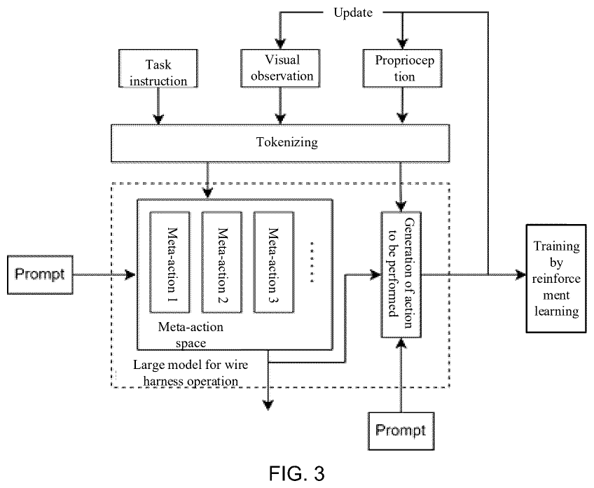

The reward function is defined according to input data including visual observation and proprioceptive data and the output of the large model to enhance its adaptability and execution efficiency in specific wire harness operation tasks, with an expression as follows:

$$R = {\sum }_{t = 0}^{T} {γ}^{t} {r}_{t} ( {v}_{t} , {p}_{t} , {q}_{t} , {\dot{q}}_{t} , {\ddot{q}}_{t} ) ,$$

in which rₜ(vₜ, pₜ, qₜ, \dot{q}ₜ, \ddot{q}ₜ) indicates an instant reward calculated according to a current state of the humanoid robot and the joint-motor parameters when performing an action at time horizon t; γ is a discount factor; T is a time horizon; vₜ indicates visual observation; pₜ indicates perception data; qₜ indicates an angle of a motor joint when performing an action, \dot{q}ₜ indicates a speed of the motor joint when performing an action, and \ddot{q}ₜ indicates an acceleration of the motor joint when performing an action.
S4, joint-motor parameters are generated, with a flow of this step shown in FIG. 3.
S41, text instruction I, the visual observation vₜ and proprioceptive data of the humanoid robot are discretized and tokenized to obtain discretized data as an input of the large model.
S42, a joint dynamics representation corresponding to each data in the wire-harness-operation meta-action dataset is extracted using a Transformer encoder in the large model for the wire harness operation of the humanoid robot, the joint dynamics representation is coded to obtain a joint dynamics feature, and all joint dynamics features are integrated to generate a meta-action space M.
S43, a joint dynamics feature is dynamically selected by the large model for the wire harness operation of the humanoid robot based on the discretized data, and joint-motor parameters for generalized execution of actions are generated according to the dynamically selected joint dynamics feature, with an expression as follows:

$$m = {f}_{1} ( {v}_{t} , l , {p}_{t} , M ) ,$$

$$[ {q}_{t} , {\dot{q}}_{t} , {\ddot{q}}_{t} ] = {f}_{2} ( {v}_{t} , l , {p}_{t} , m ) ,$$

in which m indicates the dynamically selected joint dynamics feature, qₜ indicates an angle of a motor joint when performing an action, \dot{q}ₜ indicates a speed of the motor joint when performing an action, and \ddot{q}ₜ indicates an acceleration of the motor joint when performing an action.
S44: parameters for which data, including the visual observation and the proprioception data, are varied due to changes to environment caused by the humanoid robot performing the wire harness operation are collected, so as to generate joint-motor parameters for a next wire harness operation.
S5, a basic strategy and a residual strategy are acquired.

Strategy transfer is performed on the joint-motor parameters obtained in step S42 for deploying in a robot to obtain the basic strategy, and the robot performs the wire harness operation based on the basic strategy. For example, when a text task instruction “perform a routing task” is input, the humanoid robot autonomously picks up the wire harness and routes it on the tooling plate along a position of a U-shaped frame according to a scene picture of the tooling plate and the wire harness observed by a head camera. For a failed operation of placing the wire harness in the U-shaped clip, the humanoid robot dynamically selects a routing skill operation mᵣₒᵤₜₑ from the meta-action space M based on a current state and rich a priori knowledge of the large model, and performs the routing operation again.

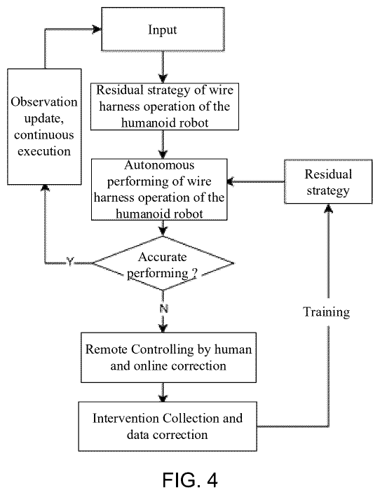

Specifically, a flow of acquiring the residual strategy is shown in FIG. 4, which includes following steps.
S51, the step S5 is executed with real-time monitoring by human, and when the basic strategy of the robot is abnormal, autonomous performing by the humanoid robot is interrupted by a remote operation, and online correction is performed.
S52, interruption data and correction data are collected so as to generate the residual strategy by using reinforcement learning.

Through the step S5, empirical knowledge of wire harness operations and intervention instructions of human behaviors are continuously accumulated in a real harness operation environment, and the residual strategy can be trained, thus realizing lifelong learning of the wire harness operations.
S6, the wire harness operation of the humanoid robot is performed based on the basic strategy and the residual strategy.

The above is only specific embodiments of the present disclosure, but the protection scope of the present disclosure is not limited to this, and various equivalent modifications or substitutions within the technical scope disclosed by the present disclosure may occur to those of skill familiar with the art and should be encompassed within the protection scope of the present disclosure. Therefore, the protection scope of the present disclosure shall be subject to the protection scope of the claims.

1. A training method of a large model for wire harness operation of a humanoid robot based on a meta-action space, comprising:
constructing wire-harness-operation meta-actions based on human wire harness operations;
acquiring wire-harness-operation meta-actions of the humanoid robot, and constructing a wire-harness-operation meta-action dataset based on the wire-harness-operation meta-actions;
training the large model for the wire harness operation of the humanoid robot using reinforcement learning based on the wire-harness-operation meta-action dataset, and defining a reward function of reinforcement learning based on an output of the large model for the wire harness operation of the humanoid robot;
acquiring input data, outputting joint-motor parameters using the trained large model for the wire harness operation of the humanoid robot and updating the input data in real time based on the joint-motor parameters, the input data comprising text instructions, visual observation, and robot perception data;
acquiring a basic strategy based on the joint-motor parameters, and training the large model for the wire harness operation of the humanoid robot to acquire a residual strategy in a lifelong learning mode with human behavior intervention based on the basic strategy; and
performing the wire harness operation of the humanoid robot based on the basic strategy and the residual strategy.

2. The training method according to claim 1, wherein each of the wire-harness-operation meta-actions comprises a wire harness routing task operation, a wire harness wrapping task operation, and a wire harness inspection task operation.

3. The training method according to claim 2, wherein:
the wire harness routing task operation refers to a robot arranging multiple wire harnesses on a tooling plate as required and fix positions of the wire harnesses through U-shaped clips arranged on the tooling plate, comprising first picking-up, routing, first straightening, and moving to a next routing position;
wherein the first picking-up refers to the robot picking up two specific position points of a wire harness, and lifting the wire harness to a first preset height at a specified speed, with no deviation of picking-up points of the wire harness during the first picking-up, the routing and the first straightening operations;
the routing is performed on a basis of the first picking-up, in which a robot moves and arranges the wire harness from the first picking-up in a U-shaped clip;
the first straightening is performed on a basis of the first picking-up, in which two arms of the robot move towards two ends of the wire harness along a direction of the wire harness to straighten the wire harness; and
the moving to the next routing position is performed after the routing is finished, in which the two arms of the robot release the wire harness and move to the next routing position;
the wire harness wrapping task operation refers to the robot picking up an adhesive tape to wrap multiple wire harnesses on the pre-routed tooling plate, comprising: second picking-up, wrapping, and tearing off the adhesive tape;
wherein the second picking-up refers to the two arms of the robot picking up position points of the adhesive tape and lifting the adhesive tape to a second preset height at a preset speed, with no deviation of picking-up points of the adhesive tape during the whole picking-up;
the wrapping is performed on a basis of the second picking-up, in which the robot grasps the adhesive tape to wrap multiple wire harnesses on the tooling plate; and
the tearing off the adhesive tape is performed on a basis of wrapping, in which the wrapping adhesive tape is cut off from the wrapped wire harness; and
the wire harness inspection task operation refers to the robot installing the assembled wire harness on an inspection platform, and docking a connecting socket equipped on the inspection platform with a connector at an end of the wire harness, comprising: third picking-up and placing, plugging, second straightening and moving to a next plugging position;
wherein the third picking-up and placing refers to the robot picking up two position points of the wire harness, moving to a third preset height above the inspection platform, placing the wire harness on the inspection platform, and releasing the wire harness;
the plugging refers to that one arm of the robot picks up an end of the wire harness, while the other arm of the robot picks up a connector at the end, and the two arms of the robot move to plug the connector into a corresponding slot of the inspection platform;
the second straightening refers to that the two arms of the robot grasp the wire harness and move towards the two ends along the direction of the wire harness so as to straighten the wire harness; and
the moving to the next plugging position is performed after the plugging is completed, in which the two arms of the robot release the wire harness and move to the next plugging position on the inspection platform.

4. The training method according to claim 1, wherein constructing the wire-harness-operation meta-action dataset comprises:
teaching the robot and collecting all robot actions during the teaching; and
sorting and classifying all collected robot actions into different wire-harness-operation meta-actions based on the wire-harness-operation meta-actions, so as to obtain the wire-harness-operation meta-action dataset by integration.

5. The training method according to claim 4, wherein the teaching is virtual reality teaching.

6. The training method according to claim 1, wherein an expression of the reward function is as follows:
$$R = {\sum }_{t = 0}^{T} {γ}^{t} {r}_{t} ( {v}_{t} , {p}_{t} , {q}_{t} , {\dot{q}}_{t} , {\ddot{q}}_{t} ) ,$$
wherein rₜ(vₜ, pₜ, qₜ, \dot{q}ₜ, \ddot{q}ₜ) indicates an instant reward calculated according to a current state of the humanoid robot and the joint-motor parameters when performing an action at time horizon t; γ is a discount factor; T is a time horizon; vₜ indicates visual observation; pₜ indicates perception data; qₜ indicates an angle of a motor joint when performing an action, \dot{q}ₜ indicates a speed of the motor joint when performing an action, and \ddot{q}ₜ indicates an acceleration of the motor joint when performing an action.

7. The training method according to claim 1, further comprising constructing the meta-action space based on the wire-harness-operation meta-action dataset, comprising:
extracting a joint dynamics representation corresponding to each data in the wire-harness-operation meta-action dataset, and encoding the joint dynamics representation to obtain a joint dynamics feature; and
integrating all joint dynamics features to generate the meta-action space.

8. The training method according to claim 7, wherein outputting the joint-motor parameters comprises:
discretizing the text instruction, the visual observation, and the perception data to obtain discretized data; and
dynamically selecting a joint dynamics feature based on the discretized data, and generating joint-motor parameters for generalized execution of actions obtained according to the dynamically selected joint dynamics feature, expressed as:
$$m = {f}_{1} ( {v}_{t} , l , {p}_{t} , M ) ,$$
$$[ {q}_{t} , {\dot{q}}_{t} , {\ddot{q}}_{t} ] = {f}_{2} ( {v}_{t} , l , {p}_{t} , m ) ,$$
wherein m indicates the dynamically selected joint dynamics feature, qₜ indicates an angle of a motor joint when performing an action, \dot{q}ₜ indicates a speed of the motor joint when performing an action, and \ddot{q}ₜ indicates an acceleration of the motor joint when performing an action.

9. The training method according to claim 1, wherein acquiring the basic strategy comprises: performing strategy transfer on the joint-motor parameters for deploying in a robot to obtain the basic strategy.

10. The training method according to claim 1, wherein acquiring the residual strategy comprises:
performing manual interruption and correction when the humanoid robot performs the basic strategy abnormally; and
collecting interruption data and correction data to generate the residual strategy by using reinforcement learning.
